(19) United States
(12) Patent Application Publication
(10) Pub. No.: US 2014/0181715 A1
(43) Pub. Date: Jun. 26, 2014

(54) DYNAMIC USER INTERFACES ADAPTED TO INFERRED USER CONTEXTS

(71) Applicant: MICROSOFT CORPORATION, Redmond, WA (US)

(72) Inventors: Elinor Axelrod, Kfar-Sirkin (IL); Hen Fitoussi, Tel-Aviv (IL)

(73) Assignee: Microsoft Corporation, Redmond, WA (US)

(21) Appl. No.: 13/727,137

(22) Filed: Dec. 26, 2012

(51) Int. Cl. G06F 3/0484

(52) U.S. Cl. CPC G06F 3/0484
USPC 715/771

(57) ABSTRACT

A device comprising a set of environment detectors may detect various environmental properties (e.g., location, velocity, and vibration), and may infer from these environmental properties a current context of the user (e.g., the user's attention availability, privacy, and accessible input and output modalities). Based on the current context, the device may adjust the presentation of various user interface elements of an application. For example, the velocity and vibration level detected by the device may enable an inference of the mode of transport of the user (e.g., stationary, walking, jogging, driving a car, or riding on a bus), and each mode of transport may suggest the user's available input modality (e.g., text, touch, speech, or gaze tracking) and/or output modality (e.g., high-detail visual, simplified visual, or audible), and the application may select and present corresponding element presentations for input and output user interface elements, and/or the detail of presented content.

### BACKGROUND

Within the field of computing, many scenarios involve devices that are used during a variety of physical activities. As a first example, a music player may play music while a user is sitting at a desk, walking on a treadmill, or jogging outdoors. The environment and physical activity of the user may not alter the functionality of the device, but it may be desirable to design the device for adequate performance for a variety of environments and activities (e.g., headphones that are both comfortable for daily use and sufficiently snug to stay in place during exercise). As a second example, a mobile device, such as a phone, may be used by a user who is stationary, walking, or riding in a vehicle. The mobile computer may store a variety of applications that a user may wish to utilize in different contexts (e.g., a jogging application that may track the user's progress during jogging, and a reading application that the user may use while seated). To this end, the mobile device may also feature a set of environmental sensors that detect various properties of the environment that are usable by the applications. For example, the mobile device may include a global positioning system (GPS) receiver configured to detect a geographical position, altitude, and velocity of the user, and a gyroscope or accelerometer configured to detect a physical orientation of the mobile device. This environmental data may be made available to respective applications, which may utilize it to facilitate the operation of the application.

Additionally, the user may manipulate the device as a form of user input. For example, the device may detect various gestures, such as touching a display of the device, shaking the device, or performing a gesture in front of a camera of the device. The device may utilize various environmental sensors to detect some environmental properties that reveal the actions communicated to the device by the user, and may extract user input from these environmental properties.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While respective applications of a mobile device may utilize environmental properties received from environmental sensors in various ways, it may be appreciated that this environmental information is typically used to indicate the status of the device (e.g., the geolocation and orientation of the device may be utilized to render an “augmented reality” application) and/or the status of the environment (e.g., an ambient light sensor may detect a local light level in order to adjust the brightness of the display). However, this information is not typically utilized to determine the current context of the user. For example, when the user transitions from walking to riding in a vehicle, the user may manually switch from a first application that is suitable for the context of walking (e.g., a pedestrian mapping application) to a second application that is suitable for the context of riding (e.g., a driving directions mapping application). While each application may use environmental properties in the current context of the user, the user interface of an application is typically presented statically until and unless explicitly adjusted by the user to suit the user's current context.

However, it may be appreciated that the user interface of an application may be dynamically adjusted to suit the current context inferred about the user. It may be appreciated that such adjustments may be selected not (only) in response to user input from the user and/or the detected environment properties of the environment (e.g., adapting the brightness in view of the detected ambient light level), but also in view of the context of the user.

Presented herein are techniques for configuring a device to infer a current context of the user, based on the environmental properties provided by the environmental sensors, and to adjust the user interface of an application to satisfy the user's inferred current context. For example, in contrast with adjusting the volume level of a device in view of a detected noise level of the environment, the device may infer from the detected noise level the privacy level of the user (e.g., whether the user is in a location occupied by other individuals or is alone), and may adjust the user interface according to the inferred privacy as the current context of the user (e.g., obscuring private user information while the user is in the presence of other individuals). Given the wide range of current contexts of the user (e.g., the user's location type, privacy level, available attention, and accessible input and output modalities), various user interface elements of the user interface may be selected from at least two element presentations (e.g., a user input modality may be selected from a text, touch, voice, and gaze modalities). Many types of current contexts of the user may be inferred based on many types of environmental properties may enable the selection among many types of dynamic user interface adjustments in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a device comprising a set of environmental sensors and configured to execute a set of applications.

FIG. 2 is an illustration of an exemplary scenario featuring an inference of a physical activity of a user through environmental properties according to the techniques presented.

FIG. 3 is an illustration of an exemplary scenario featuring a dynamic composition of a user interface using element presentations selected for the current context of the user in accordance with the techniques presented herein.

FIG. 4 is a flow chart illustrating an exemplary method of inferring physical activities of a user based on environmental properties.

FIG. 5 is a component block diagram illustrating an exemplary system for inferring physical activities of a user based on environmental properties.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. INTRODUCTION

Within the field of computing, many scenarios involve a mobile device operated by a user in a variety of contexts and environments. As a first example, a music player may be operated by a user during exercise and travel, as well as while stationary. The music player may be designed to support use in variable environments, such as providing solid-state storage that is less susceptible to damage through movement; a transflective display that is visible in both indoor and outdoor environments; and headphones that are both comfortable for daily use and that stay in place during rigorous exercise. While not altering the functionality of the device between environments, these features may promote the use of the mobile device in a variety of contexts. As a second example, a mobile device may offer a variety of applications that the user may utilize in different contexts, such as travel-oriented applications, exercise-oriented applications, and stationary-use applications. Respective applications may be customized for a particular context, e.g., by presenting user interfaces that are well-adapted to the use context.

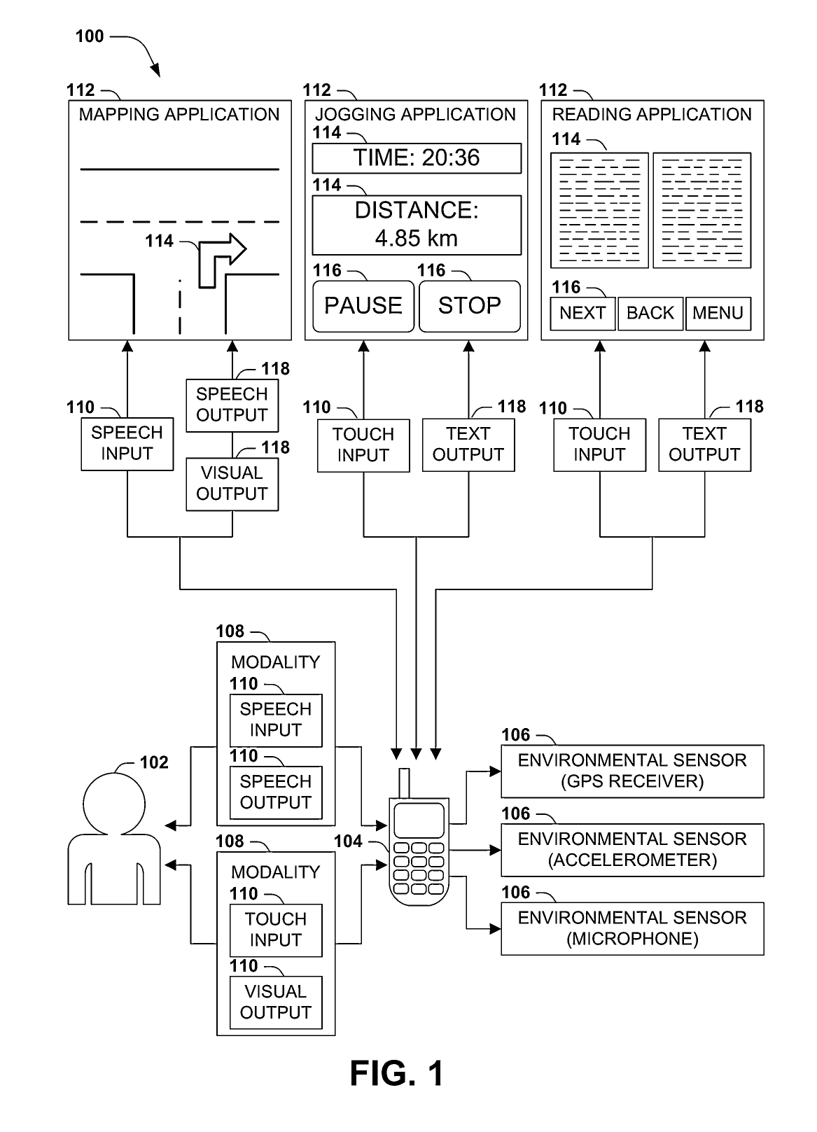

FIG. 1 presents an illustration of an exemplary scenario 100 featuring a device 104 operated by a user 102 and usable in different contexts. In this exemplary scenario 100, the device 104 features a mapping application 112 that is customized to assist the user 102 while traveling on a road, such as by automobile or bicycle; a jogging application 112, which assists the user 102 in tracking the progress of a jogging exercise, such as the duration of the jog, the distance traveled, and the user's pace; and a reading application 112, which may present documents to a user 102 that are suitable for a stationary reading experience. The device 104 may also feature a set of environmental sensors 106, such as a global positioning system (GPS) receiver configured to identify a position, altitude, and velocity of the device 104; an accelerometer or gyroscope configured to detect a tilt orientation of the device 104; and a microphone configured to receive sound input. Additionally, respective applications 112 may be configured to utilize the information provided by the environmental sensors 106. For example, the mapping application 112 may detect the current location of the device in order to display a localized map; the jogging application 112 may detect the current speed of the device 104 through space in order to track distance traveled; and the reading application 112 may use a light level sensor to detect the light level of the environment, and to set the brightness of a display component for comfortable viewing of the displayed text.

Additionally, respective applications 112 may present different types of user interfaces that are customized based on the context in which the application 112 is to be used. Such customization may include the use of the environmental sensors 106 to communicate with the user 102 through a variety of modalities 108. For example, a speech modality 108 may include speech user input 110 received through the microphone and speech output produced through a speaker, while a visual modality 108 may comprise touch user input 110 received through a touch-sensitive display component and visual output presented on the display. In these ways, the information provided by the environmental sensors 106 may be used to receive user input 110 from the user 102, and to output information to the user 102. In some such devices 104, the environmental sensors 106 may be specialized for user input 110; e.g., the microphone may be configured for particular sensitivity to receive voice input and to distinguish such voice input from background noise.

Moreover, respective applications 112 may be adapted to present user interfaces that interact with the user 102 according to the context in which the application 112 is to be used. As a first example, the mapping application 112 may be adapted for use while traveling, such as driving a car or riding a bicycle, wherein the user's attention may be limited and touch-based user input 110 may be unavailable, but speech-based user input is suitable. The user interface may therefore present a minimal visual interface with a small set of large user interface elements 114, such as a simplified depiction of a road and a directional indicator. More detailed information may be presented as speech output 118, and the application 112 may communicate with the user 102 through speech-based user input 110 (e.g., voice-activated commands detected by the microphone), rather than touch-based user input 110 that may be dangerous while traveling. The application 112 may even refrain from accepting any touch-based input in order to discourage distractions. As a second example, the jogging application 112 may be adapted for the context of a user 102 with limited visual availability, limited touch input availability, and no speech input availability. Accordingly, the user interface may present a small set of large user interface elements 114 through text output 118 that may be received through a brief glance, and a small set of large user interface controls 116, such as large buttons that may be activated with low-precision touch input. As a third example, the reading application 112 may be adapted for a reading environment based on a visual modality 108 involving high visual output 118 and precise touch-based user input 110, but reducing audial interactions that may be distracting in reading environments such as a classroom or library. Accordingly, the user interface for the reading application 112 may interact only through touch-based user input 110 and textual user interface elements 114, such as highly detailed renderings of text. In this manner, respective applications 112 may utilize the environmental sensors 106 for environment-based context and for user input 110 received from the user 102, and may present user interfaces that are well-adapted to the context in which the application 112 is to be used.

### B. PRESENTED TECHNIQUES

The exemplary scenario 100 of FIG. 1 presents several advantageous uses of the environmental sensors 106 to facilitate the applications 112, and several adaptations of the user interface elements 114 and user interface controls 116 of respective applications 112 to suit the context in which the application 112 is likely to be used. In particular, as used in the exemplary scenario 100 of FIG. 1, the environmental properties detected by the environmental sensors 106 may be interpreted as the status of the device 104 (e.g., its position or orientation), the status of the environment (e.g., the local sound level), or explicit communication with the user 102 (e.g., touch-based or speech-based user input 110). However, the environmental properties may also be used as a source of information about the context of the user 102 while using the device 104. For example, while the device 104 is attached to the user 102, the movements of the user 102 and environmental changes caused thereby may enable an inference about various properties of the location of the user, including the type of location; the presence and number of other individuals in the proximity of the user 102, which may enable an inference of the privacy level of the user 102; the attention availability of the user 102 (e.g., whether the attention of the user 102 is readily available for interaction, or whether the user 102 may be only periodically interrupted); and the input modalities that may be accessible to the user 102 (e.g., whether the user 102 is available to receive visual output, audial output, or tactile output such as vibration, and whether the user 102 is available to provide input through text, manual touch, device orientation, voice, or eye gaze). An application 112 comprising a set of user interface elements may therefore be presented by selecting, for respective user interface elements, an element presentation that Is suitable for the current context of the user 102. Moreover, this dynamic composition of the user interface may be performed automatically (e.g., not in response to user input directed by the user 102 to the device 104 and specifying the user's current context), and in a more sophisticated manner than directly using the environmental properties, which may be of limited value in selecting element presentations for the user 102.

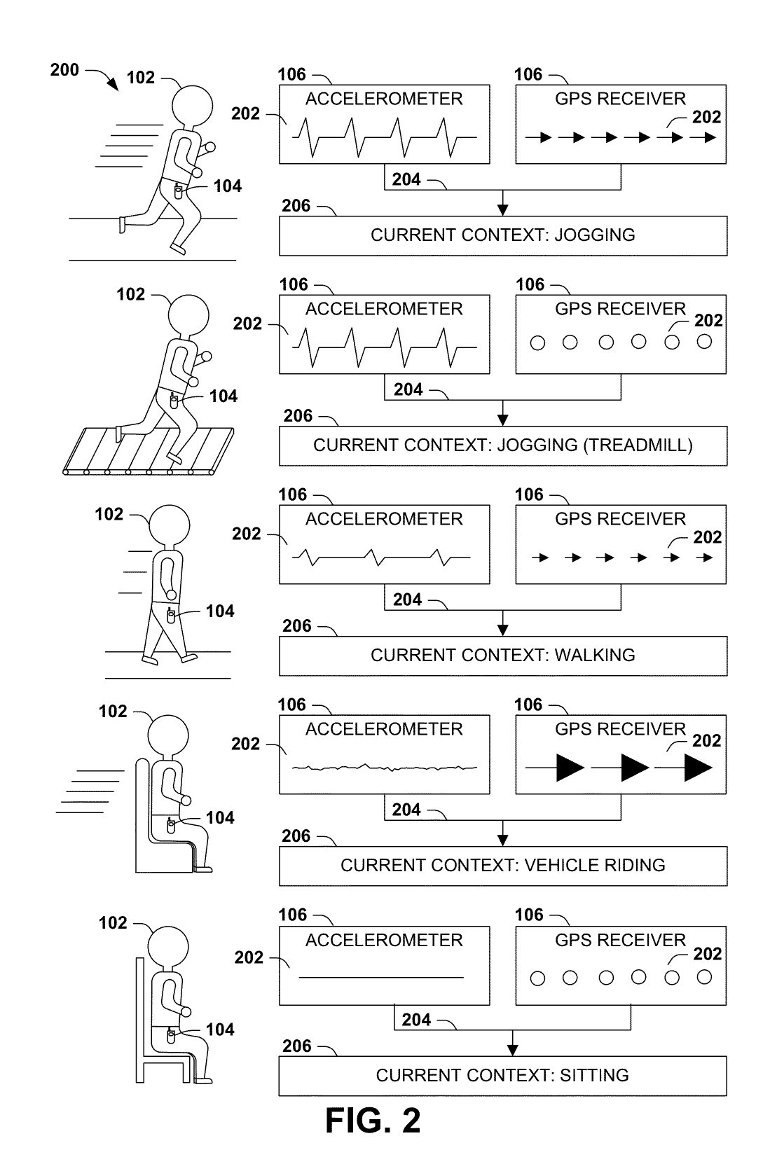

FIG. 2 presents an illustration of an exemplary scenario 200 featuring an inference of a current context 206 of a user 102 of a device 104 based on environmental properties 202 reported by respective environmental sensors 106, including an accelerometer and a global positioning system (GPS) receiver. As a first example, the user 102 may engage in a jogging context 206 while attached to the device 104. Even when the user 102 is not directly interacting with the device 104 (in the form of user input), the environmental sensors 106 may detect various properties of the environment that enable an inference 204 of the current context 206 of the user 102. For example, the accelerometer may detect environmental properties 202 indicating a modest repeating impulse caused by the user's footsteps while jogging, while the GPS receiver also detects a speed that is within the typical speed of jogging context 206. Based on these environmental properties 202, the device 104 may therefore perform an inference 204 of the jogging context 206 of the user 102. As a second example, the user 102 may perform a jogging exercise on a treadmill. While the accelerometer may detect and report the same pattern of modest repeating impulses, the GPS receiver may indicate that the user 102 is stationary. The device 104 may therefore perform an evaluation resulting in an inference 204 of a treadmill jogging context 206. As a third example, a walking context 206 may be inferred from a first environmental property 202 of a regular set of impulses having a lower magnitude than for the jogging context 206 and a steady but lower-speed direction of travel indicated by the GPS receiver. As a fourth example, when the user 102 is seated on a moving vehicle such as a bus, the accelerometer may detect a latent vibration (e.g., based on road unevenness) and the GPS receiver may detect high-velocity directional movement, leading to an inference 204 of a vehicle riding context 206. As a fifth example, when the user 102 is seated and stationary, the accelerometer and GPS receiver may both indicate very-low-magnitude environmental properties 202, and the device 104 may reach an inference 204 of a stationary context 206. In this manner, a device 104 may infer the current context 206 of the user 102 based on the environmental properties 202 detected by the environmental sensors 106.

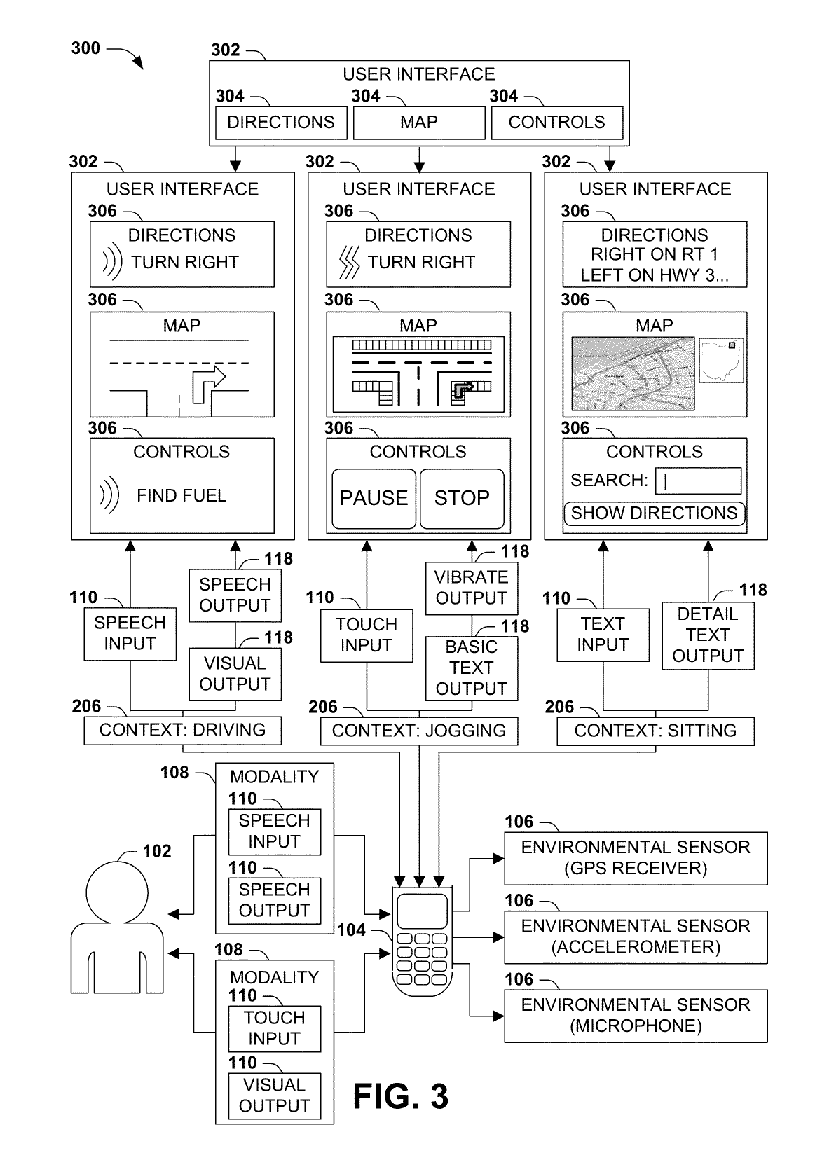

FIG. 3 presents an illustration of an exemplary scenario 300 featuring the use of an inferred current context 206 of the user 102 to achieve a dynamic, context-aware composition of a user interface 302 of an application 112. In this exemplary scenario 300, a user 102 may operate a device 104 having a set of environmental sensors 106 configured to detect various environmental properties 202, from which a current context 206 of the user 102 may be inferred. Moreover, various contexts 206 may be associated with various types of modalities 108; e.g., each context 206 may involve a selection of one or more forms of input 110 selected from a set of input modalities 108, and/or a selection of one or more forms of output 118 selected from a set of output modalities 108.

In view of this information, the device 104 may present an application 112 comprising a user interface 302 comprising a set of user interface elements 304, such as a mapping application 112 involving a directions user interface element 304; a map user interface element 304; and a controls user interface element 304. In view of the inferred current context 206 of the user 102, the device 104 may select, for each user interface element 304, an element presentation 306 that is suitable for the context 206. As a first example, the mapping application 112 may be operated in a driving context 206, in which the user input 110 of the user 102 is limited to speech, and the output 118 of the user interface 302 involves speech and simplified, driving-oriented visual output. The directions user interface element 304 may be presented as voice directions; the mapping user interface element 304 may present a simplified map with driving directions; and the controls user interface element 306 may involve a non-visual, speech analysis technique. As a second example, the mapping application 112 may be operated in a jogging context 206, in which the user input 110 of the user 102 is limited to comparatively inaccurate touch, and the output 118 of the user interface 302 involves vibration and simplified, pedestrian-oriented visual output. The directions user interface element 304 may be presented as vibrational directions (e.g., buzzing once for a left turn and twice for a right turn); the mapping user interface element 304 may present a simplified map with pedestrian directions; and the controls user interface element 306 may involve large buttons and large text that are easy to view and activate while jogging. As a third example, the mapping application 112 may be operated in a stationary context 206, such as while sitting at a workstation and planning a trip, in which the user input 110 of the user 102 is robustly available as text input and highly accurate pointing controls, and the output 118 of the user interface 302 involves detailed text and high-quality visual output. The directions user interface element 304 may be presented as a detailed, textual description of directions; the mapping user interface element 304 may present a highly detailed and interactive map; and the controls user interface element 306 may involve a sophisticated set of user interface controls providing extensive map interaction. In this manner, the user interface 302 of the application 112 may be dynamically composed based on the current context 206 of the user 102, which in turn may be automatically inferred from the environmental properties 202 detected by the environmental sensors 106, in accordance with the techniques presented herein.

### C. EXEMPLARY EMBODIMENTS

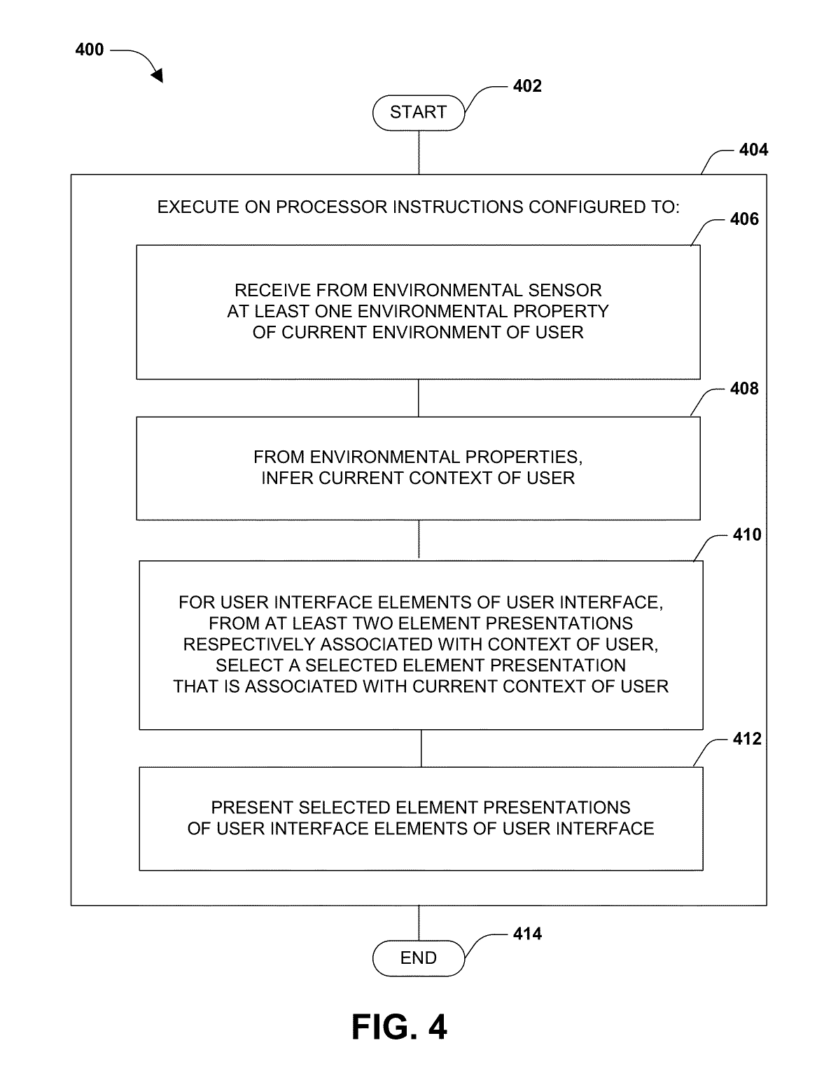

FIG. 4 presents a first exemplary embodiment of the techniques presented herein, illustrated as an exemplary method 400 of presenting a user interface 302 to a user 102 of a device 104 having a processor and an environmental sensor 106. The exemplary method 400 may be implemented, e.g., as a set of processor-executable instructions stored in a memory component of the device 104 (e.g., a memory circuit, a solid-state storage device, a platter of a hard disk drive, or a magnetic or optical device) that, when executed on a processor of the device, cause the device to operate according to the techniques presented herein. The exemplary method 400 begins at 402 and involves executing 404 the instructions on the processor. Specifically, the instructions may be configured to receive 406 from the environmental sensor 106 at least one environmental property 202 of a current environment of the user 102. The instructions are also configured to, from the at least one environmental property 202, infer 408 a current context 206 of the user 102. The instructions are also configured to, for respective user interface elements 304 of the user interface 302, from at least two element presentations 306 respectively associated with a context 206 of the user 102, select 410 a selected element presentation 306 that is associated with the current context 206 of the user 102. The instructions are also configured to present 412 the selected element presentations 306 of the user interface elements 304 of the user interface 302. By compositing the user interface 302 based on the inference of the context 206 of the user 102 from the environmental properties 202 provided by the environmental sensors 106, the exemplary method 400 operates according to the techniques presented herein, and so ends at 414.

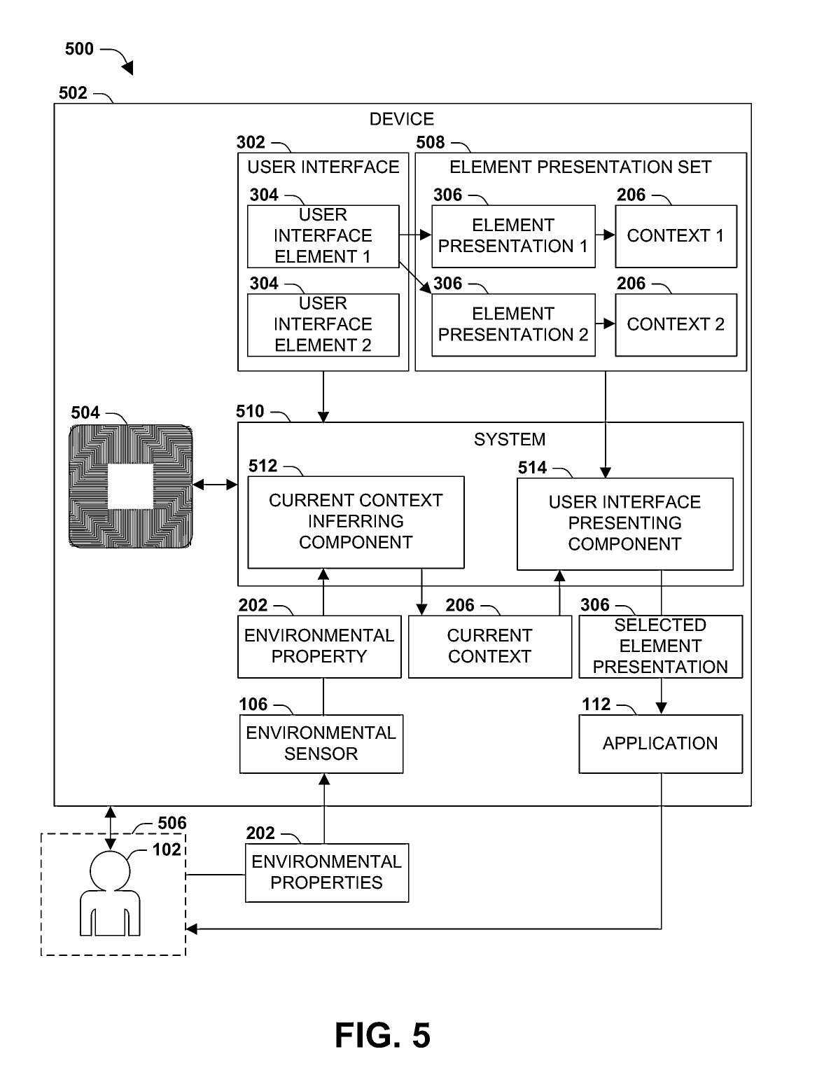

FIG. 5 presents a second embodiment of the techniques presented herein, illustrated as an exemplary scenario 500 featuring an exemplary system 510 configured to present a user interface 302 that is dynamically adjusted based on an inference of a current context 206 of a current environment 506 of a user 102 of the device 502. The exemplary system 510 may be implemented, e.g., as a set of interoperating components, each respectively comprising a set of instructions stored in a memory component (e.g., a memory circuit, a solid-state storage device, a platter of a hard disk drive, or a magnetic or optical device) of a device 502 having an environmental sensor 106, such that, when the instructions are executed on a processor 504 of the device 502, cause the device 502 to apply the techniques presented herein. The exemplary system 510 comprises a current context inferring component 512 configured to infer a current context 206 of the user 102 by receiving, from the environmental sensor 106, at least one environmental property 202 of a current environment 506 of the user 102, and to, from the at least one environmental property 202, infer a current context 206 of the user 102 (e.g., according to the techniques presented in the exemplary scenario 200 of FIG. 2). The exemplary system 510 further comprises a user interface presenting component 514 that is configured to, for respective user interface elements 304 of the user interface 302, from an element presentation set 508 comprising at least two element presentations 306 that are respectively associated with a context 206 of the user 102, select a selected element presentation 306 that is associated with the current context 206 of the user 102 as inferred by the current context inferring component 512; and to present the selected element presentations 306 of the user interface elements 304 of the user interface 302 to the user 102. In this manner, the interoperating components of the exemplary system 510 enable the presentation of the user interface 302 in a manner that is dynamically adjusted based on the inference of the current context 206 of the user 102 in accordance with the techniques presented herein.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

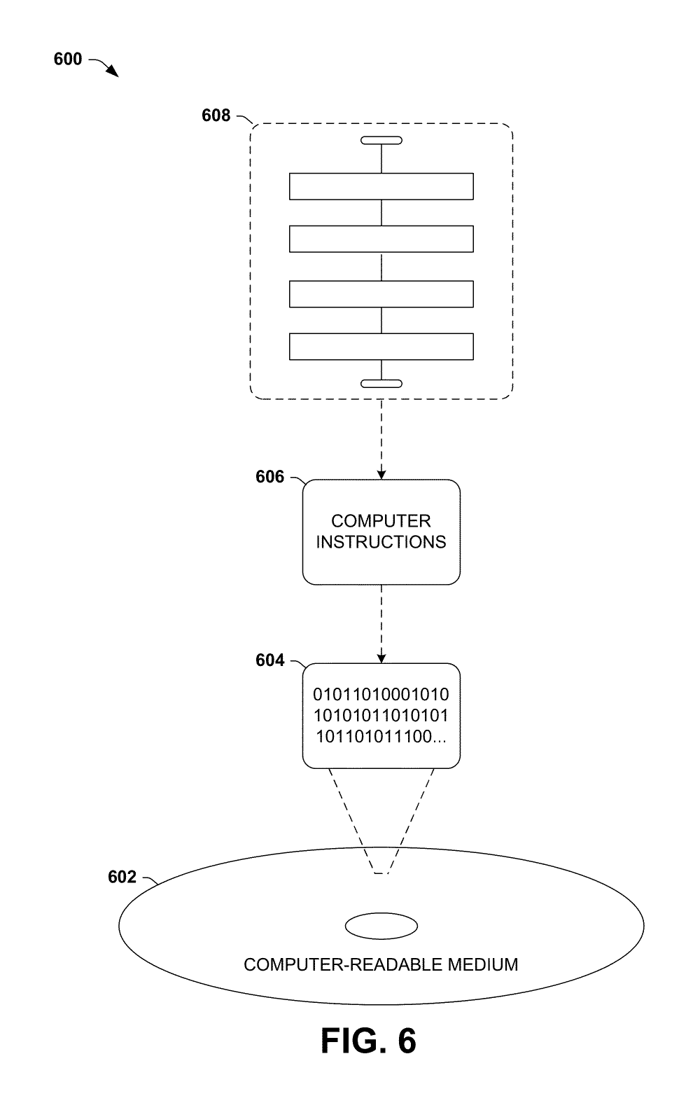

An exemplary computer-readable medium that may be devised in these ways is illustrated in FIG. 6, wherein the implementation 600 comprises a computer-readable medium 602 (e.g., a CD-R, DVD-R, or a platter of a hard disk drive), on which is encoded computer-readable data 604. This computer-readable data 604 in turn comprises a set of computer instructions 606 configured to operate according to the principles set forth herein. In one such embodiment, the processor-executable instructions 606 may be configured to perform a method of adjusting a user interface 302 inferring user context of a user 102 based on environmental properties, such as the exemplary method 510 of FIG. 5. In another such embodiment, the processor-executable instructions 506 may be configured to implement a system for inferring physical activities of a user based on environmental properties, such as the exemplary system of FIG. 5. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. VARIATIONS

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 400 of FIG. 4 and the exemplary system 510 of FIG. 5) to confer individual and/or synergistic advantages upon such embodiments.

D1. Scenarios

A first aspect that may vary among embodiments of these techniques relates to the scenarios wherein such techniques may be applied.

As a first variation of this first aspect, the techniques presented herein may be used with many types of devices 104, including mobile phones, tablets, personal information manager (PIM) devices, portable media players, portable game consoles, and palmtop or wrist-top devices. Additionally, these techniques may be implemented by a first device that is in communication with a second device that is attached to the user 102 and comprises the environmental sensors 106. The first device may comprise, e.g., a physical activity identifying server, which may evaluate the environmental properties 202 provided by the first device, arrive at an inference 204 of a current context 206, and inform the first device of the inferred current context 206.

As a second variation of this first aspect, the techniques presented herein may be used with many types of environmental sensors 106 providing many types of environmental properties 202 about the environment of the user 102. For example, the environmental properties 202 may be generated by one or more environmental sensors 106 selected from an environmental sensor set comprising a global positioning system (GPS) receiver configured to detect a geolocation, a linear velocity, and/or an acceleration; a gyroscope configured to detect an angular velocity; a touch sensor configured to detect touch input that does not comprise user input (e.g., an accidental touching of a touch-sensitive display, such as the palm of a device who is holding the device); a wireless communication signal sensor configure to detect a wireless communication signal (e.g., a cellular signal strength, which may be indicative of the distance of the device 104 from a wireless communication signal source at a known location); a gyroscope or accelerometer configured to detect a device orientation (e.g., a tilt impulse, or vibration level); an optical sensor, such as a camera, configured to detect a visibility level (e.g., an ambient light level); a microphone configured to detect a noise level of the environment; a magnetometer configured to detect a magnetic field; and a climate sensor configured to detect a climate condition of the location of the device 104, such as temperature or humidity. A combination of such environmental sensors 106 may enable a set of overlapping and/or discrete environmental properties 202 that provide a more robust indication of the current context 206 of the user 102. These and other types of contexts 206 may be inferred in accordance with the techniques presented herein.

D2. Context Inference Properties

A second aspect that may vary among embodiments of these techniques relates to the types of information utilized to reach an inference 204 of a current context 206 from one or more environmental properties 202.

As a first variation of this second aspect, the inference 204 of the current context 206 of the user 102 may include many types of current contexts 206. For example, the inferred current context 206 may include the location type of the location of the device 104 (e.g., whether the location of the user 102 and/or device 104 is identified as the home of the user 102, the workplace of the user 102, a street, a park, or a particular type of store). As a second example, the inferred current context 206 may include a mode of transport of a user 102 who is in motion (e.g., whether the user 102 is walking, jogging, riding a bicycle, driving or riding a car, riding on a bus or train, or riding in an airplane). As a third example, the inferred current context 206 may include an attention availability of the user 102 (e.g., whether the user 102 is idle and may be readily notified by the device 104; whether the user 102 is active, such that interruptions by the device 104 are to be reserved for significant events; and whether the user 102 is engaged in an uninterruptible activity, such that element presentations 306 that interrupt the user 102 are to be avoided). As a fourth example, the inferred current context 206 may include a privacy condition of the user 102 (e.g., if the user 102 is alone, the device 104 may present sensitive information and may utilize voice input and output; but if the user 102 is in a crowded location, the device 104 may avoid presenting sensitive information and may utilize input and output modalities other than voice). As a fifth example, the device 104 may infer a physical activity of the user 102 that does not comprise user input directed by the user 102 to the device 104, such as a distinctive pattern of vibrations indicating that the user 102 is jogging.

As a second variation of this second aspect, the techniques presented herein may enable the inference 204 of many types of contexts 206 of the user 102. As a first example, a walking context 206 may be inferred from a regular set of impulses of a medium magnitude and/or a speed of approximately four kilometers per hour. As a second example, a jogging context 206 may be inferred from a faster and higher-magnitude set of impulses and/or a speed of approximately six kilometers per hour. As a third example, a standing context 206 may be inferred from a zero velocity, neutral impulse readings from an accelerometer, a vertical tilt orientation of the device 104, and optionally a dark reading from a light sensor indicating the presence of the device in a hip pocket, while a sitting context 206 may provide similar environmental properties 202 but may be distinguished by a horizontal tilt orientation of the device 104. As a fourth example, a swimming physical activity may be inferred from an impedance metric indicating the immersion of the device 104 in water. As a fifth example, a bicycling context 206 may be inferred from a regular circular tilt motion indicating a stroke of an appendage to which the device 104 is attached and a speed exceeding typical jogging speeds. As a sixth example, a vehicle riding context 206 may be inferred from a background vibration (e.g., created by uneven road surfaces) and a high speed. Moreover, in some such examples, the device 104 may further infer, along with a vehicle riding physical activity, at least one vehicle type that, when the vehicle riding physical activity is performed by the user 102 while attached to the device and while the user 102 is riding in a vehicle of the vehicle type, results in the environmental property 202. For example, the velocity, rate of acceleration, and magnitude of vibration may distinguish when the user 102 is riding on a bus, in a car, or on a motorcycle.

As a third variation of this second aspect, many types of additional information may be evaluated together with the environmental properties 202 to infer the current context 206 of the user 102. As a first example, the device 104 may have access to a user profile of the user 102, and may use the user profile to facilitate the inference of the current context 206 of the user 102. For example, if the user 102 is detected to be riding in a vehicle, the device 104 may refer to a user profile of the user 102 to determine whether the user is controlling the vehicle or is only riding in the vehicle. As a second example, if the device 104 is configured to detect a geolocation, the device 104 may distinguish between a transient presence at a particular location (e.g., within a range of coordinates) from a presence of the device 104 at the location for a duration exceeding a duration threshold. For instance, different types of inferences may be derived based on whether the user 102 passes through a location such as a store or remains at the store for more than a few minutes. As a third example, the device 104 may be configured to receive a second current context 206 indicating the activity of a second user 102 (e.g., a companion of the first user 102), and may infer the current context 206 of the first user 102 in view of the current context 206 of the second user 102 as well as the environmental properties of the first user 102. As a fourth example, the device 104 that utilizes a geolocation of the user 102 may further identify the type of location, e.g., by querying a mapping service with a request to provide at least one location descriptor describing the location of the user 102 (e.g., a residence, an office, a store, a public street, a sidewalk, or a park), and upon receiving such location descriptors, may infer the current context 206 of the user 102 in view of the location descriptors describing the user's location. These and other types of information may be utilized in implementations of the techniques presented herein.

D3. Context Inference Architectures

A third aspect that may vary among embodiments of these techniques involves the architectures that may be utilized to achieve the inference of the current context 206 of the user 102.

As a first variation of this third aspect, the user interface 302 that is dynamically composited through the techniques presented herein may be attached to many types of processes, such as the operating system, a natively executing application, and an application executing within a virtual machine or serviced by a runtime, such as a web application executing within a web browser. The user interface 302 may also be configured to present an interactive application, such as a utility or game, or a non-interactive application, such as a comparatively static web page with content adjusted according to the current context 206 of the user 102.

As a second variation of this third aspect, the device 104 may achieve the inference 204 of the current context 206 of the user 102 through many types of notification mechanisms. As a first example, the device may provide an environmental property querying interface, and an application may (e.g., at application launch and/or periodically thereafter) query the environmental property querying interface to receive the latest environmental properties 202 detected by the device 104. As a second example, the device 104 may utilize an environmental property notification system that may be invoked to request with an environmental property notification service to receive detected environmental properties 202. An application may therefore register with the environmental property notification service, and when an environmental sensor 106 detects an environmental property 202, the environmental property notification service may send a notification thereof to the application. As a third example, the device 104 may utilize a delegation architecture, wherein an application specifies different types of user interfaces that are available for different contexts 206 (e.g., an application manifest indicating the set of element presentations 306 to be used in different contexts 206), and an operating system or runtime of the device 104 may dynamically select and adjust the element presentations 306 of the user interface 302 of the application as the inference of the current context 206 of the user 102 is achieved and changes.

As a third variation of this third aspect, the device 104 may utilize an external services to facilitate the inference 204. As a first interact with the user 102 to determine the context 206 represented by a set of environmental properties 202. For example, if the environmental properties 202 are difficult to correlate with any currently identified context 206, or if the user 102 performs a currently identified context 206 in a peculiar or user-specific manner that leads to difficult-to-infer environmental properties 202, the device 104 may ask the user 102, or a third user (e.g., as part of a “mechanical Turk” solution), to identify the current context 206 resulting in the reported environmental properties 202. Upon receiving a user identification of the current context 206, the device 104 may adjust the classifier logic in order to achieve a more accurate identification of the context 206 of the user 102 upon next encountering similar environmental properties 202.

As a fourth variation of this third aspect, the inference of the current context 206 may be automatically achieved through many techniques. As a first such example, a system may comprise a context inference map that correlates respective set of environmental properties 202 with a context 206 of the user 102. The context inference map may be provided by an external service, specified by a user, or automatically inferred, and the device 104 may store the context inference map and refer to it to infer the current context 206 of the user 104 from the current set of environmental properties 202. This variation may be advantageous, e.g., for enabling a computationally efficient detection that reduces the ad hoc computation and expedites the inference for use in realtime environments. As a first such example, the device 104 may utilize one or more physical activity profiles that are configured to correlate environmental properties 202 with a current context 206, and that may be invoked to select a physical activity profile matching the environmental properties 202 in order to infer the current context 206 of the user 102. As a second such example, the device 104 may comprise a set of one or more physical activity profiles that respectively indicate a value or range of an environmental property 202 that may enable an inference 204 of the current context 206 (e.g., a specified range of accelerometer impulses and speed indicating a jogging context 206). The physical activity profiles may be generated by a user 102, automatically generated by one or more statistical correlation techniques, and/or a combination thereof, such as user manual tuning of automatically generated physical activity profiles. The device 104 may then infer the current context 206 by comparing a set of collected environmental properties 202 with those of the physical activity profiles in order to identify a selected physical activity profile. As a third such example, the device 104 may comprise an ad hoc classification technique, e.g., an artificial neural network or a Bayesian statistical classifier. For instance, the device 104 may comprise a training data set that identifies sets of environmental properties 202 as well as the context 206 resulting in such environmental properties 202. The classifier logic may be trained using the training data set until it is capable of recognizing such contexts 206 with an acceptable accuracy. As a fourth such example, the device 104 may delegate the inference to an external service; e.g., the device 104 may send the environmental properties 202 to an external service, which may return the context 206 inferred for such environmental properties 202.

As a fifth variation of this third aspect, the accuracy of the inference 204 of the current context 206 may be refined during use by feedback mechanisms. As a first such example, respective contexts 206 may be associated with respective environmental properties 202 according to an environmental property significance, indicating the significance of the environmental property to the inference 204 of the current context 206. For example, a device 104 may comprise an accelerometer and a GPS receiver. A vehicle riding context 206 may place higher significance on the speed detected by the GPS receiver than the accelerometer (e.g., if the user device 104 is moving faster than speeds achievable by an unassisted human, the vehicle riding context 206 may be automatically selected). As a second such example, a specific set of highly distinctive impulses may be indicative of a jogging context 206 at a variety of speeds, and thus may place high significance on the environmental properties 202 generated by the accelerometer than those generated by the GPS receiver. The inference 204 performed by the classifier logic may accordingly weigh the environmental properties 202 according to the environmental property significances for respective contexts 206. These and other variations in the inference architectures may be selected according to the techniques presented herein.

D4. Element Presentation

A fourth aspect that may vary among embodiments of these techniques relates to the selection and use of the element presentations of respective user interface elements 304 of a user interface 302.

As a first variation of this fourth aspect, at least one user interface element 304 may utilize a range of element presentations 306 reflecting different element input modalities and/or output modalities. As a first such example, in order to suit a particular current context 206 of the user 104, a user interface element 304 may present a text input modality (e.g., a software keyboard); a manual pointing input modality (e.g., a point-and-click); a device orientation input modality (e.g., a tilt or shake interface); a manual gesture input modality (e.g., a touch or air gesture interface); a voice input modality (e.g., a keyword-based or natural-language speech interpreter); and a gaze tracking input modality (e.g., an eye-tracking interpreter). As a second such example, in order to suit a particular current context 206 of the user 104, a user interface element 304 may present a textual visual output modality (e.g., a body of text); a graphical visual output modality (e.g., a set of icons, pictures, or graphical symbols); a voice output modality (e.g., a text-to-speech interface); an audible output modality (e.g., a set of audible cues); and a tactile output modality (e.g., a vibration or heat indicator).

As a second variation of this fourth aspect, at least one user interface element 304 comprising a visual element presentation that is presented on a display of the device 104 may be visually adapted based on the current context 206 of the user 102. As a first example of this second variation, the visual size of elements may be adjusted for presentation on the display (e.g., adjusting a text size, or adjusting the sizes of visual controls, such as using small controls that may be precisely selected in a stationary environment and large controls that may be selected in mobile, inaccurate input environments). As a second example of this second variation, the device 104 may adjust a visual element count of the user interface 302 in view of the current context 206 of the user 102, e.g., by showing more user interface elements 304 in contexts where the user 102 has plentiful available attention, and a reduced set of user interface elements 304 in contexts where the attention of the user 102 is to be conserved.

As a third variation of this fourth aspect, the content presented by the device 104 may be adapted to the current context 206 of the user 102. As a first such example, upon inferring a current context 206 of the user 102, the device 104 may select for presentation an application that is suitable for the current context 206 (e.g., either by initiating an application matching that context 206; by bringing an application associated with that context 206 to the foreground; or simply by notifying an application 206 associated with the context 206 that the context 206 has been inferred). As a second such example, the content presented by the user interface 302 may be adapted to suit the inferred current context 206 of the user 102. For example, the content presentation of one or more element presentations 306 may be adapted, e.g., by presenting more extensive information when the attention of the user 102 is readily available, and by presenting a reduced and/or relevance-filtered set of information when the attention of the user 102 is to be conserved (e.g., by summarizing the information or presenting only the information that is relevant to the current context 206 of the user 102).

As a fourth variation of this fourth aspect, as the inference of the context 206 changes from a first current context 206 to a second current context 206, the device 102 may dynamically recompose the user interface 302 of an application to suit the different current contexts 206 of the user 104. For example, for a particular user interface element 304, the user interface may switch from a first element presentation 306 (suitable for the first current context 206) to a second element presentation 306 (suitable for the second current context 206). Moreover, the device 104 may present a visual transition therebetween; e.g., upon a switching from a stationary context 206 to a mobile context 206, a mapping application may fade out a text entry user interface (e.g., a text keyboard) and fade in a visual control for a voice interface (e.g., a list of recognized speech keywords). These and other types of element presentations 306 may be selected for the user interface elements 304 of the user interface 302 in accordance with the techniques presented herein.

### E. COMPUTING ENVIRONMENT

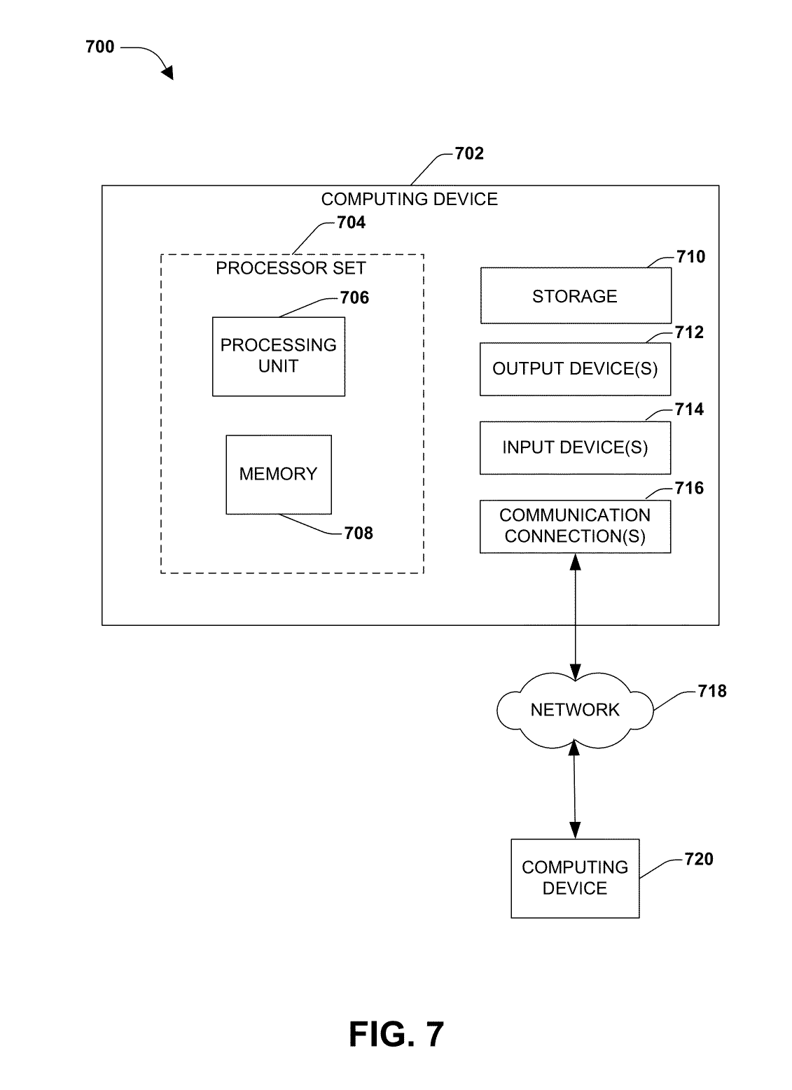

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 702 configured to implement one or more embodiments provided herein. In one configuration, computing device 702 includes at least one processing unit 706 and memory 708. Depending on the exact configuration and type of computing device, memory 708 may be volatile (such as RAM, for example), non-volatile (such as ROM, flash memory, etc., for example) or some combination of the two, such as the processor set 704 illustrated in FIG. 7.

In other embodiments, device 702 may include additional features and/or functionality. For example, device 702 may also include additional storage (e.g., removable and/or non-removable) including, but not limited to, magnetic storage, optical storage, and the like. Such additional storage is illustrated in FIG. 7 by storage 710. In one embodiment, computer readable instructions to implement one or more embodiments provided herein may be in storage 710. Storage 710 may also store other computer readable instructions to implement an operating system, an application program, and the like. Computer readable instructions may be loaded in memory 708 for execution by processing unit 706, for example.

The term “computer readable media” as used herein includes computer storage media. Computer storage media includes volatile and nonvolatile, removable and non-removable media implemented in any method or technology for storage of information such as computer readable instructions or other data. Memory 708 and storage 710 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 702. Any such computer storage media may be part of device 702.

Device 702 may also include communication connection(s) 716 that allows device 702 to communicate with other devices. Communication connection(s) 716 may include, but is not limited to, a modem, a Network Interface Card (NIC), an integrated network interface, a radio frequency transmitter/receiver, an infrared port, a USB connection, or other interfaces for connecting computing device 702 to other computing devices. Communication connection(s) 716 may include a wired connection or a wireless connection. Communication connection(s) 716 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 702 may include input device(s) 714 such as keyboard, mouse, pen, voice input device, touch input device, infrared cameras, video input devices, and/or any other input device. Output device(s) 712 such as one or more displays, speakers, printers, and/or any other output device may also be included in device 702. Input device(s) 714 and output device(s) 712 may be connected to device 702 via a wired connection, wireless connection, or any combination thereof. In one embodiment, an input device or an output device from another computing device may be used as input device(s) 714 or output device(s) 712 for computing device 702.

Components of computing device 702 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 702 may be interconnected by a network. For example, memory 708 may be comprised of multiple physical memory units located in different physical locations interconnected by a network.

Those skilled in the art will realize that storage devices utilized to store computer readable instructions may be distributed across a network. For example, a computing device 720 accessible via network 718 may store computer readable instructions to implement one or more embodiments provided herein. Computing device 702 may access computing device 720 and download a part or all of the computer readable instructions for execution. Alternatively, computing device 702 may download pieces of the computer readable instructions, as needed, or some instructions may be executed at computing device 702 and some at computing device 720.

### F. USAGE OF TERMS

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-readable storage device comprising instructions that, when executed on a processor of a device having an environmental sensor, cause the device to present a user interface to a user of the device by:
receiving from the environmental sensor at least one environmental property of a current environment of the user;
from the at least one environmental property, inferring a current context of the user;
for respective user interface elements of the user interface, from at least two element presentations respectively associated with a context of the user, selecting a selected element presentation that is associated with the current context of the user; and
presenting the selected element presentations of the user interface elements of the user interface.

2. The computer-readable storage device of claim 1, at least one of the environmental properties selected from an environmental property set comprising:
a geolocation of the device;
an orientation of the device;
a velocity of the device;
a vibration level of the device;
a noise level of a location of the device; and
a visibility level of a location of the device.

3. The computer-readable storage device of claim 1, the current context of the user selected from a current context set comprising:
a location type of the device;
a mode of transport of the user;
an attention availability of the user;
a privacy condition of the user; and
a physical activity of the user not comprising user input directed by the user to the device.

4. The computer-readable storage device of claim 1, at least one of the element presentations selected from an element input modality set comprising:
a text input modality;
a manual pointing input modality;
a device orientation input modality;
a manual gesture input modality;
a voice input modality; and
a gaze tracking input modality.

5. The computer-readable storage device of claim 1, at least one of the element presentations selected from an element output modality set comprising:
a textual visual output modality;
a graphical visual output modality;
a voice output modality;
an audible output modality; and
a tactile output modality.

6. A method of presenting a user interface to a user of a device having a processor and an environmental sensor, the method comprising:
executing on the processor instructions configured to:
receive from the environmental sensor at least one environmental property of a current environment of the user;
from the at least one environmental property, infer a current context of the user;
for respective user interface elements of the user interface, from at least two element presentations respectively associated with a context of the user, select a selected element presentation that is associated with the current context of the user; and
present the selected element presentations of the user interface elements of the user interface.

7. The method of claim 6:
at least one environmental property comprising a location of the user; and
inferring the current context of the user comprising: inferring the current context after detecting a presence of the device at the location for a duration exceeding a duration threshold.

8. The method of claim 6:
the instructions further configured to receive a second current context of a second user; and
inferring the current context of the user comprising: inferring the current context of the user from the at least one environmental property and the second current context of the second user.

9. The method of claim 6:
at least one environmental property comprising a location of the user; and
inferring the current context of the user comprising:
querying a service for at least one location descriptor describing the location of the user; and
inferring the current context of the user comprising: inferring the current context of the user from the at least one environmental property and the at least one location descriptor describing the location of the user.

10. The method of claim 6:
at least one element presentation comprising a visual element presentation to be presented on a display of the device; and
selecting the element presentation comprising: for at least one visual element presentation, selecting a visual size of the visual element presentation to be presented on the display of the device.

11. The method of claim 6:
at least one element presentation comprising a visual element presentation to be presented on a display of the device; and
selecting the element presentation comprising: for at least one visual element presentation, selecting an element count of the user interface elements comprising the visual element presentation to be presented on the display of the device.

12. The method of claim 6:
at least one element presentation comprising a content presentation of content; and
selecting the element presentation comprising: for at least one element presentation, adjusting the content presentation of the content presented by the element presentation.

13. The method of claim 6, the instructions further configured to, upon inferring a second current context that is different from a first current context of the user:
for respective user interface elements of the user interface, from at least two element presentations respectively associated with a context of the user, select a selected second element presentation that is associated with the current context of the user, the selected second element presentation comprising a different element presentation than a selected first element presentation selected for the first current context; and
for respective visual elements, present a transition from the selected first element presentation for the first current context to the selected second element presentation for the second current context.

14. A system for presenting a user interface to a user of a device having a processor, a memory, and an environmental sensor, the system comprising:
a current context inferring component comprising instructions stored in the memory that, when executed on the processor, cause the device to infer a current context of the user by:
receiving from the environmental sensor at least one environmental property of a current environment of the user; and
from the at least one environmental property, infer a current context of the user; and
a user interface presenting component comprising instructions stored in the memory that, when executed on the processor, cause the device to present the user interface to the user by:
for respective user interface elements of the user interface, from at least two element presentations respectively associated with a context of the user, select a selected element presentation that is associated with the current context of the user; and
present the selected element presentations of the user interface elements of the user interface.

15. The system of claim 14:
the environmental sensor comprising an environmental property querying interface; and
the current context inferring component configured to receive the at least one environmental property by querying the environmental property querying interface.

16. The system of claim 14:
the environmental sensor comprising an environmental property notification service; and
the current context inferring component configured to receive the at least one environmental property by:
requesting the environmental property notification service to send a notification to the current context inferring component upon receiving an environmental property; and
receiving a notification of the environmental property from the environmental property notification service.

17. The system of claim 14:
the system further comprising a user profile of the user; and
the current context inferring component configured to infer the current context of the user from the at least one environmental property and the user profile of the user.

18. The system of claim 14:
the system further comprising a context inference map identifying, for respective at least one environmental properties, the current context of the user; and
the current context inferring component configured to infer the current context of the user from the at least one environmental property and the context inference map.

19. The system of claim 14, further comprising: an application selecting component configured to, upon detecting a current context of the user, select for presentation an application that is associated with the current context of the user.

20. The system of claim 14, the user interface presenting component configured to select the selected element presentation by:
sending the current context of the user to an element presentation selecting service; and
receiving from the element presentation selecting service the selected element presentation for the current context of the user.
